(19) United States
(12) Patent Application Publication
(10) Pub. No.: US 2005/0011372 A1
(43) Pub. Date: Jan. 20, 2005

(54) System and method of introducing ozone treated humidified air into a refrigerated sevice display case or refrigerated storage room

(75) Inventors: J. Michael Corrigan, Gurnee, IL (US); Paul Jones, Gurnee, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Corrigan Corporation of America

(21) Appl. No.: 10/725,097

(22) Filed: Dec. 1, 2003

Related U.S. Application Data
(60) Provisional application No. 60/487,689, filed on Jul. 16, 2003.

(51) Int. Cl. A01J 11/00

(52) U.S. Cl. 99/468

(57) ABSTRACT

A system and method for introducing ozone treated air into a product holding space comprises an air atomizing nozzle positioned proximate the product holding space and including a water inlet and an air inlet. A water supply and a control selectively supply pressurized water from the supply to the atomizing nozzle water inlet. An air compressor is operatively connected between an ozone generator and the atomizing nozzle air inlet for delivering pressurized ozone to the atomizing nozzle so that the nozzle delivers ozonated vapor into the product holding space.

### FIELD OF THE INVENTION

The invention relates to humidification systems for seafood or the like and, more particularly, to introducing ozone treated air into the humidification system.

### BACKGROUND OF THE INVENTION

Humidification systems have found widespread use for grocery service display cases or the like to provide a water vapor that surrounds the displayed product and prevents dehydration, thus extending shelf life and preserving freshness. Such humidification systems typically include an air atomizing nozzle, compressed air and a water supply. A control selectively supplies pressurized water from the water supply and pressurized air from the compressor to the air atomizing nozzle to provide a very small droplet sized mist.

While conventional misting or humidification systems address problems of dehydration of seafood, poultry, meat and the like, sanitation and other problems may still exist. This is particularly true with, for example, a seafood service case where the product will be handled by employees, introducing bacteria while handling the various products. Also, as with all perishable food, decay causing bacteria will shorten the shelf life and adversely effect the quality of the products.

### SUMMARY OF THE INVENTION

In accordance with the invention, ozone is used to treat an air space through air atomizing humidification.

Broadly, there is disclosed herein an improvement in a humidification system including an atomizing nozzle, a water supply, and a control selectively supplying pressurized water and compressed air from the supply to the atomizing nozzle so that an atomized vapor pattern is provided. The improvement comprises an ozone generator and an air compressor operatively connected between the ozone generator and the atomizing nozzle for delivering pressurized ozone to the atomizing nozzle so that the nozzle delivers ozonated vapor.

There is disclosed in accordance with another aspect of the invention, a humidification system for a product holding space comprising an air atomizing nozzle positioned proximate the product holding space and including a water inlet and an air inlet. A water supply and a control selectively supply pressurized water from the supply to the atomizing nozzle water inlet. An air compressor is operatively connected between an ozone generator and the atomizing nozzle air inlet for delivering pressurized ozone to the atomizing nozzle so that the nozzle delivers ozonated vapor into the product holding space.

It is a feature of the invention that the air atomizing nozzle delivers ozonated air into the product holding space when the pressurized water is not being supplied.

There is disclosed in accordance with a further aspect of the invention, a humidification system for a refrigerated display case comprising a plurality of air atomizing nozzles positioned proximate the display case and each including a water inlet and an air inlet. A water supply and a control selectively supply pressurized water from the supply to the atomizing nozzle water inlets. An air compressor is operatively connected between an ozone generator and the atomizing nozzles air inlets for delivering pressurized ozone to the atomizing nozzles so that the nozzles deliver ozonated vapor into the display cases.

There is disclosed in accordance with yet a further aspect of the invention the method of providing ozone treated air onto seafood or the like provided in a display case comprising: positioning an air atomizing nozzle proximate to the display case, the nozzle including a water inlet and an air inlet: intermittently connecting the atomizing nozzle to a source of pressurized water; and providing an ozone generator connected to the atomizing nozzle air inlet for delivering pressurized ozone treated air to the atomizing nozzle so that the nozzle delivers ozonated vapor into the display case.

There is disclosed in accordance with yet a further aspect of the invention the method of providing ozone treated air into a refrigerated perishable product storage room comprising: positioning an air atomizing nozzle or nozzles within the storage room, each nozzle including a water inlet and an air inlet; intermittently connecting each atomizing nozzle to a source of pressurized water; and providing an ozone generator connected to each atomizing nozzle air inlet for delivering pressurized ozone treated air to each atomizing nozzle so that the nozzle delivers ozonated vapor into the storage room.

Further features and advantages of the invention will be readily apparent from the specification and from the drawings.

### BRIEF DESCRIPTION OF THE DRAWINGS

FIG. 1 is a perspective view of a humidification system for a refrigerated display case or storage room in accordance with the invention;

FIG. 2 is a sectional view of an air atomizing nozzle of the humidification system of FIG. 1;

FIG. 3 is a plan view of a humidification system according to an alternative embodiment of the invention;

FIG. 4 is a plan view of a humidification system according to another embodiment of the invention; and

FIG. 5 is a schematic diagram illustrating the humidification system of any of the previous embodiments used with a plurality of air atomizing nozzles.

### DETAILED DESCRIPTION OF THE INVENTION

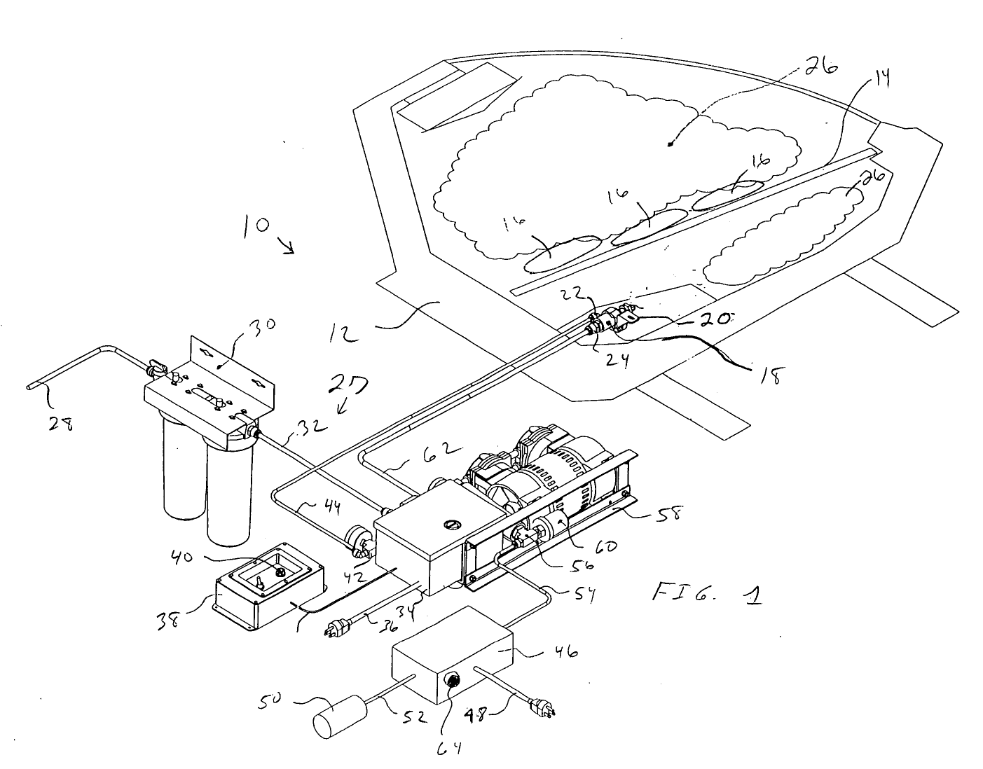

Referring initially to FIG. 1, a humidification system 10 for a refrigerated space 12, such as a service display case or storage room, is illustrated. The refrigerated space 12 may be of any known kind and in general use. In the illustrated embodiment of the invention the refrigerated space 12 generally includes a product holding space 14 holding products such as seafood 16. The seafood 16 may be of any and all kinds. As an alternative to a seafood case, the space 12 could be a deli case or the like storing meat, poultry, cheese, etc, or a produce case storing produce such as, for example, lettuce, beans, fruits, melons, etc. Alternatively, the space 12 could be used in a seafood and meat processing area or any area or space in which humidity is required and bacteria, molds, mildew, etc. may present problems. As such, the present invention is not limited to a refrigerated service display case.

The humidification system 10 includes an air atomizing nozzle 18 secured via a bracket 20 to the display case 12. The atomizing nozzle 18 includes a water inlet 22 and an air inlet 24. In accordance with the invention, the atomizing nozzle 18 delivers vapor mixed with ozone, generally illustrated at 26, into the product holding space 14. As is known, the ozone acts as a disinfectant which can control bacteria and help prevent the formation of mildew, molds and bacteria within the ozone humidified area.

The humidification system 10 includes a control system 27 connected to a cold water inlet 28 from a municipal or treated water supply. The inlet 28 is connected to a dual water filter assembly 30 to remove sediment and reduce bacteria in the water. A typical pressure at which community water is supplied is in the order of 40 psi. Filtered water is delivered via a tube 32 to a controller 34 connected via a power cord 36 to an electrical supply. The controller 34 is in turn connected to a timer control module 38 including a system cycle time adjustment knob 40. Although not shown in FIG. 1, the controller 34 includes a solenoid valve selectively operated by the timer control module 38 to deliver pressurized water through a regulator 42 to a water pipe 44 connected to the nozzle water inlet 22. Particularly, the controller 34 selectively supplies pressurized water from the supply inlet 28 to the atomizing nozzle water inlet 22 so that atomized vapor is provided.

In accordance with the invention, a conventional ozone generator 46 is powered by a power cord 48. An air dryer 50 supplies dried air via a tube 52 to the ozone generator 46. The ozone generator 46 has an outlet tube 54 connected via a tee connector 56 to the inlet side of an air compressor 58. An ambient air inlet filter 60 is connected to the opposite side of the tee connector 56. Air piping 62 is connected from the outlet of the compressor 58 to the atomizing nozzle air inlet 24. The ozone generator 46 includes a control knob 64 for controlling the amount of ozone being generated.

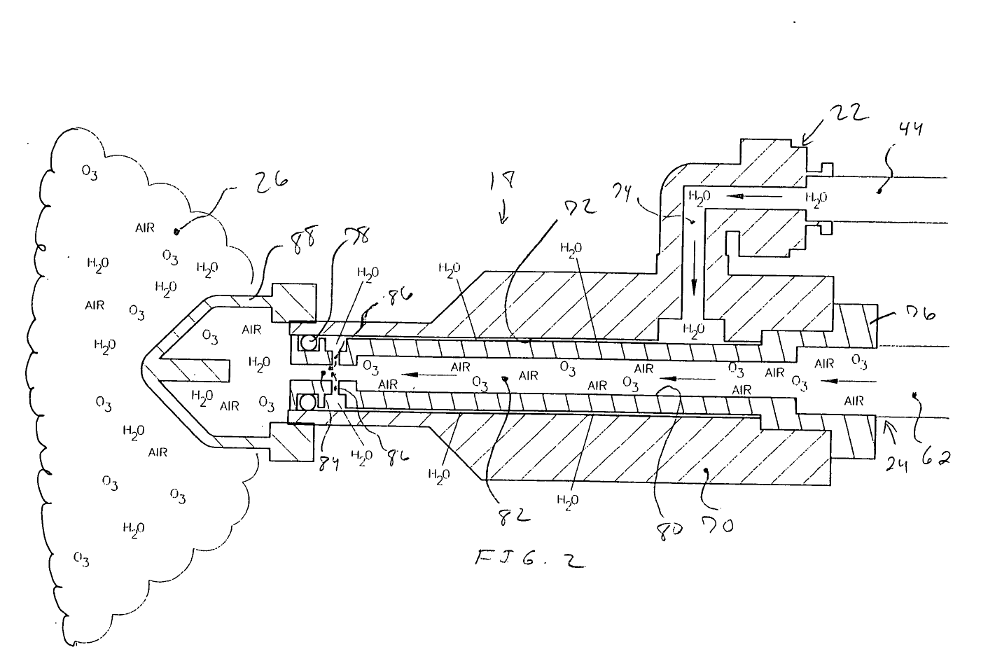

Referring to FIG. 2, the atomizing nozzle 18 is illustrated in greater detail. The atomizing nozzle 18 comprises a housing 70 having a through bore 72. The water inlet 22 comprises an internal water port 74 opening into the through bore 72. An elongate spool-like element 76 is received in the through bore 72 and is sealed at an outlet end with an O-ring 78. The spool element 76 includes a through bore 80 defining an internal air port 82 from the air inlet 24. The air port 82 includes a narrowed outlet 84. Water jets 86 through the nozzle element 76 deliver pressurized water which passes through the water port 74 and in a space between the spool element 76 and the housing 70. Pressurized water and ozonated air are mixed in the outlet area 84 and pass outwardly where the ozonated vapor is dispersed by a resonator tip 88.

The air atomizing nozzle 18 is of generally conventional construction. As will be appreciated, other designs for air atomizing nozzles could also be used in conjunction with the present invention.

As described, ozone is brought into the refrigerated grocery service display case 12 via the humidification system 10. Generated ozone is drawn from the ozone generator 46 into the inlet side of the atomizing compressor 58 along with ambient air drawn through the air filter 60. The ozonated air travels through the compressor 58 and is delivered to the atomizing nozzle via the air piping 62. At the nozzle 18, ozonated air is mixed with pressurized water thus creating the fine air atomized vapor 26. Ozonated vapor travels through the space 12. Case surfaces and product displayed receives the sanitation benefits of the ozonated vapor.

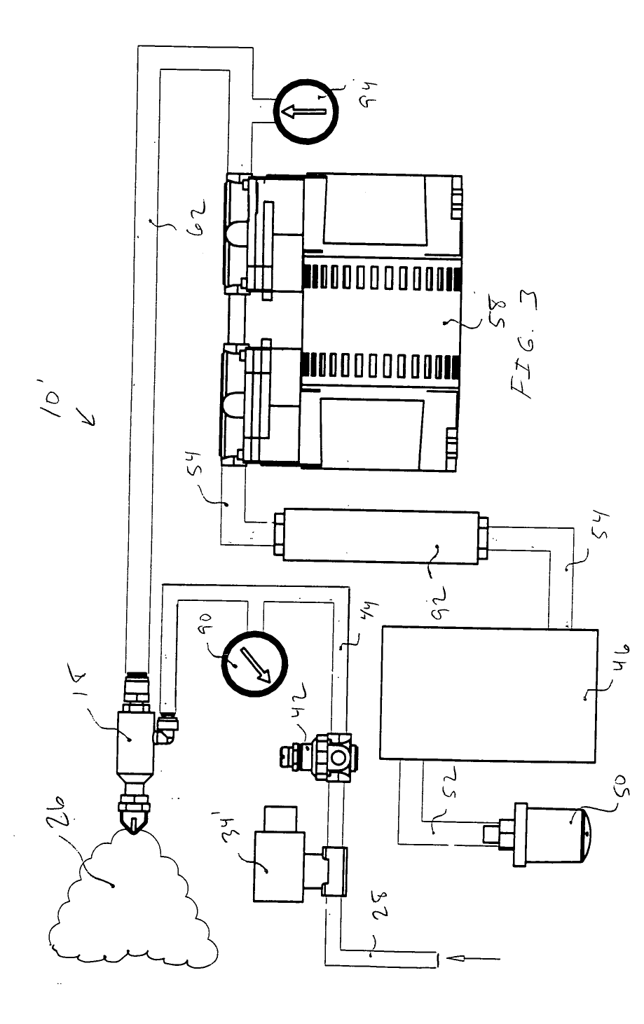

Referring to FIG. 3, a humidification system 10′ in accordance with the invention is illustrated. The humidification 10′ is generally similar to the humidification system 10 of FIG. 1. As such, like elements are illustrated with like reference numerals and are not discussed in detail herein.

Particularly, the humidification system 10′ differs in illustrating a water inlet solenoid valve 34′ connected to the cold water inlet line 28. Although not shown, the water inlet solenoid valve 34′ could be controlled through a timer, such as the timer 38 of FIG. 1, or by any other control system. Additionally, a water pressure gauge 90 is provided connected to the water tube 44 to the atomizing nozzle 18.

An air muffler 92 is connected in the line 54 from the ozone generator 46 to the air compressor 58. Additionally, an air pressure gauge 94 is connected in the line 62 from the air compressor 58 to the atomizing nozzle 18.

In the embodiment of FIG. 3, the humidification system 10′ uses the air supplied only from the dryer 50 for providing ozonated air to the compressor 58 eliminating the requirement of the air inlet filter 60 of FIG. 1.

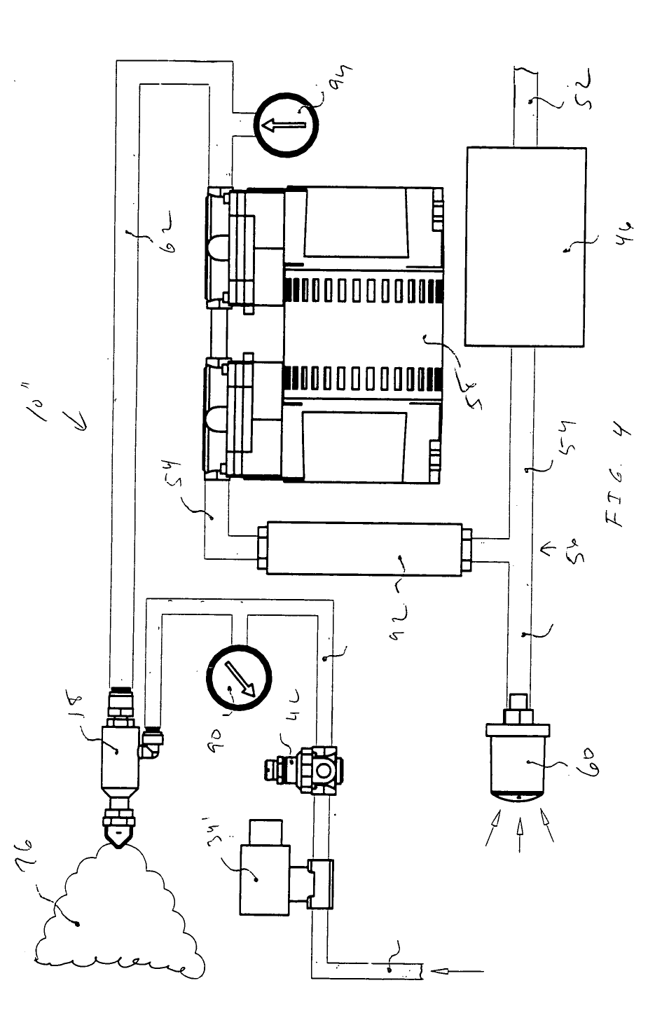

Referring to FIG. 4, a humidification system 10″ in accordance with another embodiment of the invention is illustrated. Again, like reference numerals illustrate like components. The humidification system 10″ is generally similar to the humidification system 10′, except that the air inlet filter 60 and tee connector 56 shown in FIG. 1 are utilized in this embodiment.

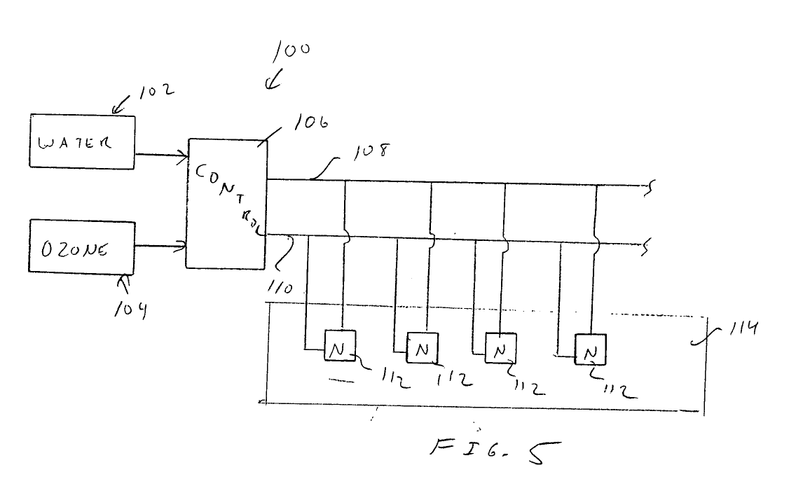

In the embodiments discussed above, a single air atomizing nozzle 18 is used. Referring to FIG. 5, a humidification system 100 is illustrated including a water supply 102 and an ozone generator 104. The water supply 102 may be generally similar to the supply inlet 28 and filter 30 of FIG. 1. The ozone generator 104 may be similar to the ozone generator 46 of FIG. 1, and related components. The water supply 102 and ozone generator 104 are connected to a control system 106. The control system 106 may be generally similar to any of the control systems discussed above relative to FIGS. 1, 3 and 4. Particularly, the control system 106 includes a water outlet line 108 and an ozonated air outlet line 110. The lines 108 and 110 are connected to a plurality of nozzles 112. Each nozzle 112 is positioned proximate a display case 114 for delivering ozonated vapor into a particular area of the display case 114. The humidification system operates generally similar to that discussed, except for the use of multiple nozzles 112.

Thus, as described, the air compressor in each embodiment draws air through an ozone generator forcing ozone into an atomizing nozzle body where it mixes with filtered water and is regulated into the nozzle. The ozonated air that does not react with the water and the nozzle is also dispelled into the space to be treated. Moreover, while the water supply is selectively controlled to intermittently connect the missing nozzle to a source of pressurized water, the ozone generator delivers ozonated air into the product holding space even when the pressurized water is not connected to the atomized missing nozzle. As is apparent, the compressor could alternatively be controlled along with the water supply so that ozone is delivered only with the vapor. The humidified ozone is thus adapted to prevent the formation of mildew, molds, bacteria and the like within the ozone humidified area. The humidification system as described herein can be applied as a single unit for a smaller space application, as with FIGS. 1, 3 and 4, or with multiple units for larger space applications, as in FIG. 5, where high relative humidities in the order of 60% to 98% are desirable.

Thus, in accordance with the invention, there is provided a system and method for introducing ozonated vapor into a refrigerated space.

1. In a humidification system including an atomizing nozzle, a water supply and a control selectively supplying pressurized water from the supply to said atomizing nozzle so that atomized vapor is provided, the improvement comprising:
an ozone generator; and
an air compressor operatively connected between the ozone generator and the atomizing nozzle for delivering pressurized ozone to the atomizing nozzle so that the nozzle delivers ozonated vapor.

2. The improvement of claim 1 further comprising an air inlet filter connected between the ozone generator and the air compressor.

3. The improvement of claim 1 further comprising an air drier connected to an inlet of the ozone generator.

4. The improvement of claim 1 further comprising a muffler connected between the ozone generator and the air compressor.

5. A humidification system for a product holding space comprising:
an air atomizing nozzle positioned proximate the product holding space and including a water inlet and an air inlet;
a water supply and a control selectively supplying pressurized water from the supply to said atomizing nozzle water inlet;
an ozone generator; and
an air compressor operatively connected between the ozone generator and the atomizing nozzle air inlet for delivering pressurized ozone to the atomizing nozzle so that the nozzle delivers ozonated vapor into the product holding space.

6. The humidification system of claim 5 further comprising an air inlet filter connected between the ozone generator and the air compressor.

7. The humidification system of claim 5 further comprising an air drier connected to an inlet of the ozone generator.

8. The humidification system of claim 5 further comprising a muffler connected between the ozone generator and the air compressor.

9. The humidification system of claim 5 wherein the air atomizing nozzle delivers ozonated air into the product holding space when the pressurized water is not being supplied.

10. The humidification system of claim 5 wherein the water supply and control comprises a timer for intermittently supplying pressurized water from the supply to said atomizing nozzle water inlet.

11. A humidification system for a refrigerated display case comprising:
a plurality of air atomizing nozzles positioned proximate the display case and each including a water inlet and an air inlet;
a water supply and a control selectively supplying pressurized water from the supply to said atomizing nozzle water inlets;
an ozone generator; and
an air compressor operatively connected between the ozone generator and the atomizing nozzle air inlets for delivering pressurized ozone to the atomizing nozzles so that the nozzles deliver ozonated vapor into the display case.

12. The humidification system of claim 11 wherein the air atomizing nozzles deliver ozonated air into the product holding space when the pressurized water is not being supplied.

13. The humidification system of claim 11 wherein the water supply and control comprises a timer for intermittently supplying pressurized water from the supply to said atomizing nozzle water inlet.

14. The method of providing ozone treated air onto seafood or the like provided in a display case comprising:
positioning an air atomizing nozzle proximate the display case, the nozzle including a water inlet and an air inlet;
intermittently connecting said atomizing nozzle to a source of pressurized water; and
providing an ozone generator connected to the atomizing nozzle air inlet for delivering pressurized ozone treated air to the atomizing nozzle so that the nozzle delivers ozonated vapor into the display case.

15. The method of claim 14 wherein the air atomizing nozzles deliver ozonated air into the product holding space when the source of pressurized water is not connected to the atomizing nozzle.

16. The method of claim 14 wherein delivering pressurized ozone treated air to the atomizing nozzle further comprises dispelling ozonated air that has not reacted with pressurized water into the display case.

17. The method of providing ozone treated air into a refrigerated perishable product storage room comprising:
positioning an air atomizing nozzle or nozzles within the storage room, the nozzle or nozzles including a water inlet and an air inlet;
intermittently connecting each atomizing nozzle to a source of pressurized water; and
providing an ozone generator connected to each atomizing nozzle air inlet for delivering pressurized ozone treated air to each atomizing nozzle so that the nozzle delivers ozonated vapor into the storage room.
